(19) United States
(12) Patent Application Publication
(10) Pub. No.: US 2025/0307165 A1
(43) Pub. Date: Oct. 2, 2025

(54) SYSTEMS AND METHODS FOR CACHE ENTRY REPLACEMENT

(71) Applicant: Advanced Micro Devices, Inc., Santa Clara, CA (US)

(72) Inventors: Niranjan Kumar Soundararajan, Bangalore (IN); Patrick J. Shyvers, Fort Collins, CO (US)

(73) Assignee: Advanced Micro Devices, Inc., Santa Clara, CA (US)

(21) Appl. No.: 18/622,042

(22) Filed: Mar. 29, 2024

(51) Int. Cl. G06F 12/0891

(52) U.S. Cl. CPC G06F 12/0891; G06F 2212/6046

(57) ABSTRACT

A method for cache entry replacement can include monitoring, by at least one physical processor, a first utilization of a first set of cache entries of a cache and a second utilization of a second set of cache entries of the cache. The method can additionally include selecting, by the at least one physical processor and in response to the monitoring, a first replacement policy for the first set of cache entries and a second replacement policy for the second set of cache entries. The method can also include simultaneously applying, by the at least one physical processor and in response to the selecting, the first replacement policy when performing cache entry replacement in the first set of cache entries and the second replacement policy when performing cache entry replacement in the second set of cache entries. Various other methods and systems are also disclosed.

### BACKGROUND

Caching structures such as instruction caches, data caches, and Branch Target Buffers (BTBs) can impact performance in modern processor cores by improving the overall throughput of the core by holding useful entries that are expected to recur. A BTB, for example, can provide target locations for branches that are predicted taken or for unconditional jumps. The correct target locations can allow the front-end to be fully utilized instead of stalling until a target is available post decode or execute. For complex instruction set (CISC)-based processors, this decode or execute delay can be significant. Thus, BTB can contribute to performance gains. Similarly, the instruction and data cache performance can contribute to performance gains because miss penalties increase with increasing pipeline depth.

Replacement techniques can play a role in choosing a useful set of entries to cache. For example, replacement techniques can decrease misses by retaining useful entries based on different criteria such as reuse distance, recent usage, thrash resistance, etc. Modern cache entry replacement systems focus on applying an effective replacement technique for an entire cache structure.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an example system for cache entry replacement.

FIG. 2 is a block diagram of an additional example system for cache entry replacement.

FIG. 3 is a flow diagram of example methods for cache entry replacement.

FIG. 4 is a set of graphical illustrations of example cache entry replacement techniques.

FIG. 5 is a set of graphical illustrations of example applications of cache entry replacement techniques.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for cache entry replacement. For example, by monitoring utilizations of sets of cache entries, selecting a first replacement policy for a first set of cache entries and a second replacement policy for a second set of cache entries, and simultaneously applying the replacement policies when performing cache entry replacement in the sets of cache entries, the disclosed systems and methods can achieve improved performance of computer processors. This improved performance arises when different sets in the cache entries are of different nature, resulting in the behavior observed in them differing. Consequently using the same replacement technique (e.g., based on the same criteria) across all sets can be sub-optimal. Instead of applying the same replacement technique across all sets of cache entries of a cache, the disclosed systems and methods can dynamically switch between multiple replacement techniques at runtime based on observed behaviors and tune the behaviors of the sets to retain the most useful entries.

Particular implementations of the disclosed systems and methods can achieve numerous additional benefits. For example, some implementations can achieve seamless transition between different insertion states that two or more different replacement schemes (e.g., least recently used (LRU) and static re-reference interval prediction (SRRIP)) provide. Some of these implementations can also enable the seamless switching with negligible hardware. Further, some implementations can allow the different sets to utilize the replacement policy that performs best for them based on the performance counters (PCs) they observe.

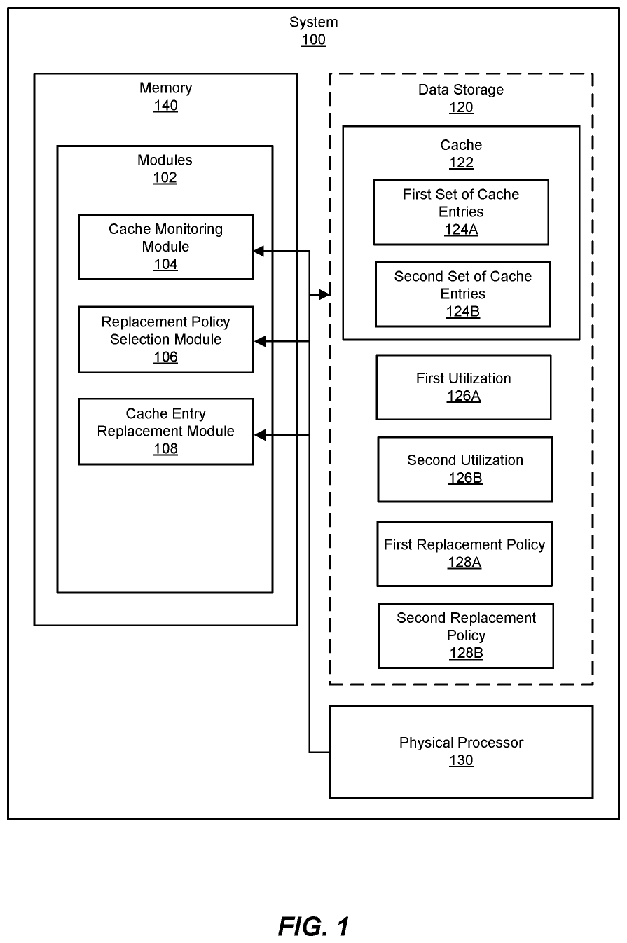

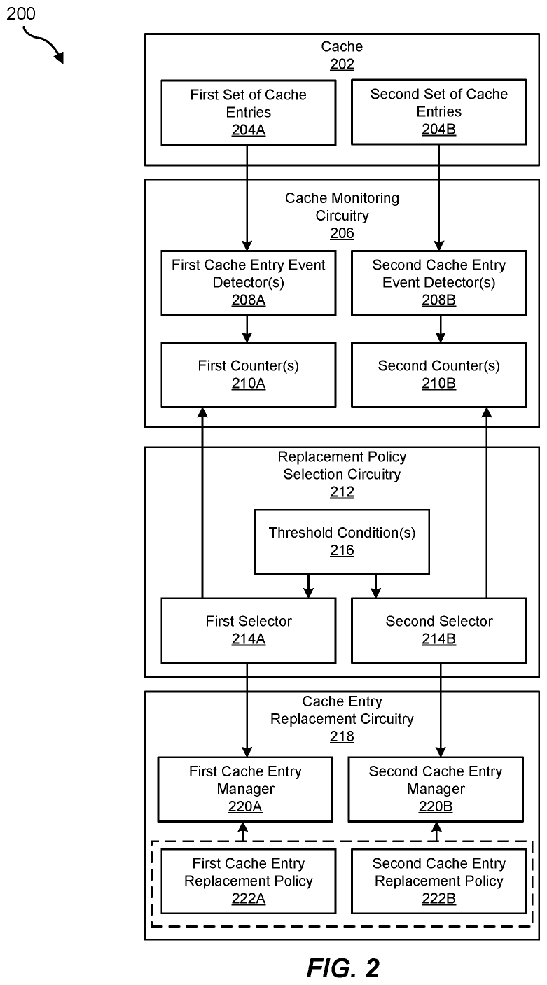

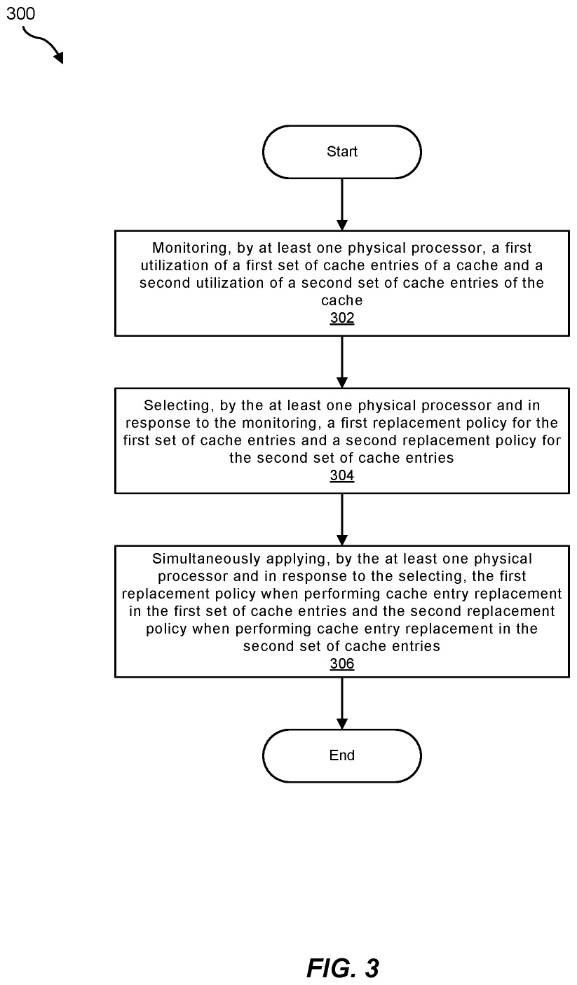

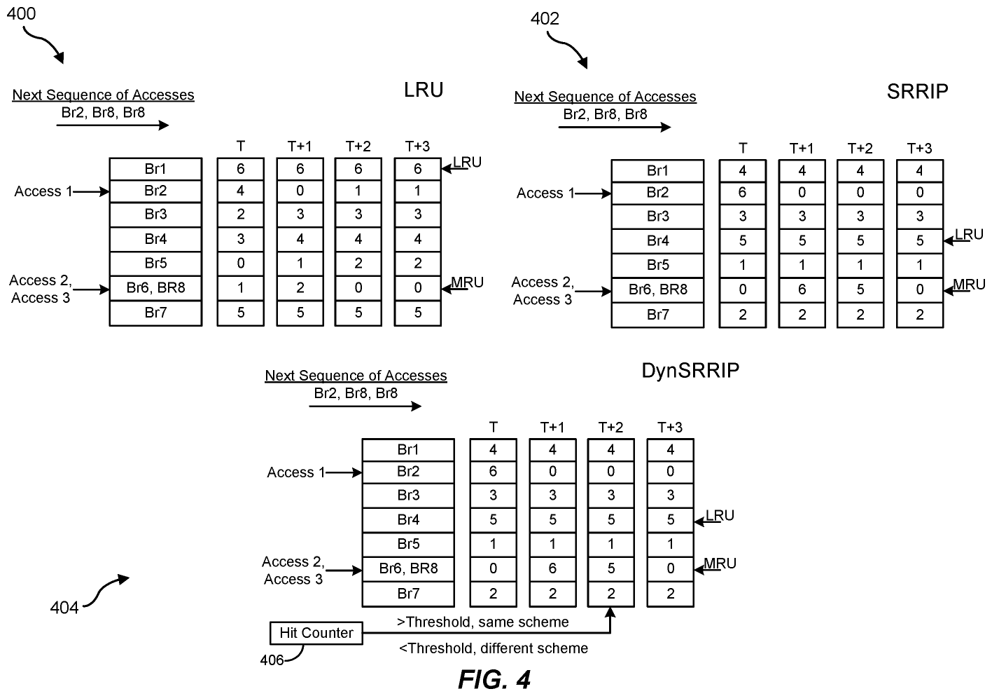

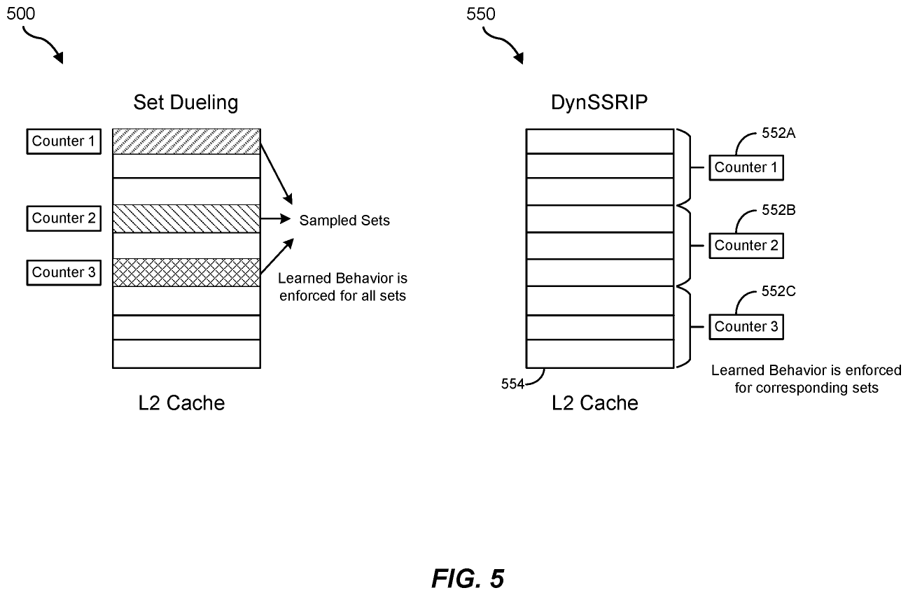

The following will provide, with reference to FIGS. 1 and 2, detailed descriptions of example systems for cache entry replacement. Detailed descriptions of corresponding computer-implemented methods will also be provided in connection with FIG. 3. In addition, detailed descriptions of example cache entry replacement techniques and applications thereof will be provided in connection with FIGS. 4 and 5.

In one example, a device can include cache monitoring circuitry configured to track a first utilization of a first set of cache entries of a cache and a second utilization of a second set of cache entries of the cache, replacement policy selection circuitry configured to respond to the cache monitoring circuitry by selecting a first replacement policy for the first set of cache entries and a second replacement policy for the second set of cache entries, and cache entry replacement circuitry configured to respond to the replacement policy selection circuitry by simultaneously applying the first replacement policy when performing cache entry replacement in the first set of cache entries and the second replacement policy when performing cache entry replacement in the second set of cache entries.

Another example can be the previously described example device, wherein the cache monitoring circuitry is configured to track the first utilization and the second utilization at least in part by maintaining a first counter to track the first utilization and maintaining a second counter to track the second utilization.

Another example can be any of the previously described example devices, wherein the replacement policy selection circuitry is configured to select the first replacement policy and the second replacement policy at least in part by selecting, in response to the first counter failing to meet a threshold condition, to continue to apply the first replacement policy to the first set of cache entries, and selecting, in response to the second counter meeting the threshold condition, the second replacement policy for application to the second set of cache entries.

Another example can be any of the previously described example devices, wherein the threshold condition corresponds to at least one of a threshold number of hits on a given set of cache entries, a threshold number of accesses of the given set of cache entries, or a threshold criticality of accesses of the given set of cache entries.

Another example can be any of the previously described example devices, wherein the replacement policy selection circuitry is configured to select the first replacement policy and the second replacement policy at least in part by dynamically switching, for an individual set of cache entries, from the first replacement policy to the second replacement policy in response to at least one of a hit rate or a replacement rate tracked for the individual set of cache entries meeting a threshold condition.

Another example can be any of the previously described example devices, wherein the first replacement policy and the second replacement policy include a static re-reference interval prediction replacement policy and a least recently used replacement policy.

Another example can be any of the previously described example devices, wherein the cache corresponds to one of an instruction cache, a level one data cache, a level two data cache, a level three data cache, an optimizer plus cache, or a branch target buffer.

Another example can be any of the previously described example devices, wherein the second replacement policy is different from the first replacement policy.

In one example, a system can include a memory storing a cache that includes a first set of cache entries and a second set of cache entries, and one or more physical processors configured to monitor a first utilization of the first set of cache entries of the cache and a second utilization of the second set of cache entries of the cache, select, in response to the monitored first utilization and the monitored second utilization, a first replacement policy for the first set of cache entries and a second replacement policy for the second set of cache entries, and simultaneously apply, in response to the selection of the first replacement policy and the second replacement policy, the first replacement policy when performing cache entry replacement in the first set of cache entries and the second replacement policy when performing cache entry replacement in the second set of cache entries.

Another example can be the previously described example system, wherein the one or more physical processors is configured to monitor the first utilization and the second utilization at least in part by maintaining a first counter to track the first utilization and maintaining a second counter to track the second utilization.

Another example can be any of the previously described example systems, wherein the one or more physical processors is configured to select the first replacement policy and the second replacement policy at least in part by selecting, in response to the first counter failing to meet a threshold condition, to continue to apply the first replacement policy to the first set of cache entries, and selecting, in response to the second counter meeting the threshold condition, the second replacement policy for application to the second set of cache entries.

Another example can be any of the previously described example systems, wherein the threshold condition corresponds to at least one of a threshold number of hits on a given set of cache entries, a threshold number of accesses of the given set of cache entries, or a threshold criticality of accesses of the given set of cache entries.

Another example can be any of the previously described example systems, wherein the one or more physical processors is configured to select the first replacement policy and the second replacement policy at least in part by dynamically switching, for an individual set of cache entries, from the first replacement policy to the second replacement policy in response to at least one of a hit rate or a replacement rate tracked for the individual set of cache entries meeting a threshold condition.

Another example can be any of the previously described example systems, wherein the first replacement policy and the second replacement policy include a static re-reference interval prediction replacement policy and a least recently used replacement policy.

Another example can be any of the previously described example systems, wherein the cache corresponds to one of an instruction cache, a level one data cache, a level two data cache, a level three data cache, an optimizer plus cache, or a branch target buffer.

Another example can be any of the previously described example systems, wherein the second replacement policy is different from the first replacement policy.

In one example, a method comprising monitoring, by at least one physical processor, a first utilization of a first set of cache entries of a cache and a second utilization of a second set of cache entries of the cache, selecting, by the at least one physical processor and in response to the monitoring, a first replacement policy for the first set of cache entries and a second replacement policy for the second set of cache entries, and simultaneously applying, by the at least one physical processor and in response to the selecting, the first replacement policy when performing cache entry replacement in the first set of cache entries and the second replacement policy when performing cache entry replacement in the second set of cache entries.

Another example can be the previously described example method, wherein the monitoring the first utilization and the second utilization includes maintaining a first counter to track the first utilization and maintaining a second counter to track the second utilization.

Another example can be any of the previously described example methods, wherein the selecting the first replacement policy and the second replacement policy includes dynamically switching, for an individual set of cache entries, from the first replacement policy to the second replacement policy in response to at least one of a hit rate or a replacement rate tracked for the individual set of cache entries meeting a threshold condition.

Another example can be any of the previously described example methods, wherein the first replacement policy and the second replacement policy include a static re-reference interval prediction replacement policy and a least recently used replacement policy.

FIG. 1 illustrates an example system 100 for cache entry replacement. As illustrated in this figure, example system 100 can include one or more modules 102 for performing one or more tasks. As will be explained in greater detail below, modules 102 can include a cache monitoring module 104, a replacement policy selection module 106, and a cache entry replacement module 108. Although illustrated as separate elements, one or more of modules 102 in FIG. 1 can represent portions of a single module or application.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices. One or more of modules 102 in FIG. 1 can also represent all or portions of one or more special-purpose computers configured to perform one or more tasks.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. For example, physical processor 130 can correspond to a central processing unit (CPU), a co-processing unit (e.g., graphics processing unit (GPU), accelerator processing unit (APU), compute processor, tensor, neural network (NN) processor, etc.), or combinations thereof. In one example, physical processor 130 can access and/or modify one or more of modules 102 stored in memory 140. Additionally or alternatively, physical processor 130 can execute one or more of modules 102 to facilitate cache entry replacement. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The term “modules,” as used herein, can generally refer to one or more functional components of a computing device. For example, and without limitation, a module or modules can correspond to hardware, software, or combinations thereof. In turn, hardware can correspond to analog circuitry, digital circuitry, communication media, or combinations thereof. In some implementations, the modules can be implemented as microcode (e.g., a collection of instructions running on a micro-processor, digital and/or analog circuitry, etc.) and/or one or more firmware in a graphics processing unit. For example, a module can correspond to a GPU, a trusted micro-processor of a GPU, and/or a portion thereof (e.g., circuitry (e.g., one or more device features sets and/or firmware) of a trusted micro-processor).

As illustrated in FIG. 1, example system 100 can also include one or more instances of stored data, such as data storage 120. Data storage 120 generally represents any type or form of stored data, however stored (e.g., signal line transmissions, bit registers, flip flops, software in rewritable memory, configurable hardware states, combinations thereof, etc.). For example, data storage 120 can correspond to a memory that is separate from memory 140 (e.g., a same type of memory (e.g., both RAM or both ROM, both main memory or both cache memory, etc.) or a different type of memory (e.g., one RAM and the other ROM, one main memory and the other cache memory, etc.) and/or one or more regions of memory 140. For ease of illustration and enhanced understanding, contents of memory 140 can generally represent instructions whereas contents of data storage 120 can generally represent static or variable data that can be instantiated, modified, and/or otherwise utilized by those instructions. In one example, data storage 120 includes databases, spreadsheets, tables, lists, matrices, trees, or any other type of data structure. Moreover, any or all of memory 140 and/or data storage 120 can be implemented as digital and/or analog circuitry that can be standalone circuitry and/or implemented as part of physical processor 130. Examples of data storage 120 include, without limitation, a cache 122, a first set of cache entries 124A, a second set of cache entries 124B, first utilization 126A, second utilization 126B, a first replacement policy 128A, and a second replacement policy 128B.

Example system 100 in FIG. 1 can be implemented in a variety of ways. For example, all or a portion of example system 100 can represent portions of example system 200 in FIG. 2. As shown in FIG. 2, system 200 can include a cache 202. Cache 202 can correspond to an instruction cache, a level one data cache, a level two data cache, a level three data cache, an optimizer plus cache, a branch target buffer, or any other type of cache. Additionally, cache 202 can include a first set of cache entries 204A and a second set of cache entries 204B.

As illustrated in FIG. 2, example system 200 can also include cache monitoring circuitry 206. Cache monitoring circuitry 206 can include one or more first cache entry event detector(s) 208A that can detect events (e.g., hits on cache entries, accesses of cache entries, criticality of accesses of cache entries, etc.) occurring with respect to cache entries of the first set of cache entries 204A. Additionally, cache monitoring circuitry 206 can include one or more second cache entry event detector(s) 208B that can detect events (e.g., hits on cache entries, accesses of cache entries, criticality of accesses of cache entries, etc.) occurring with respect to cache entries of the second set of cache entries 204B. Also, cache monitoring circuitry 206 can include one or more first counters 210A and one or more second counters 210B.

The one or more first counters 210A can include one or more performance counters that track a number of hits on the first set of cache entries 204A, a number of accesses of the first set of cache entries 204A, and/or a criticality of accesses of the first set of cache entries 204A. The one or more first counters 210A can be initialized to a given number (e.g., fifteen) of hits, accesses, and or criticality at startup of system 200 and then incremented and/or decremented by the one or more first cache entry event detector(s) 208A in response to detected events. For example, a hit detector of the one or more first cache entry event detector(s) 208A can increment a hit counter of the one or more first counters 210A when a cache entry in the first set of cache entries 204A sees a hit. Alternatively or additionally, a hit detector of the one or more first cache entry event detector(s) 208A can decrement a hit counter of the one or more first counters 210A in response to a detected replacement of a cache entry in the first set of cache entries 204A.

The one or more second counters 210B can include one or more performance counters that track a number of hits on the second set of cache entries 204B, a number of accesses of the second set of cache entries 204B, and/or a criticality of accesses of the second set of cache entries 204B. The one or more second counters 210B can be initialized to a given number (e.g., fifteen) of hits, accesses, and or criticality at startup of system 200 and then incremented and/or decremented by the one or more second cache entry event detector(s) 208B in response to detected events. For example, a hit detector of the one or more second cache entry event detector(s) 208B can increment a hit counter of the one or more second counters 210B when a cache entry in the second set of cache entries 204B sees a hit. Alternatively or additionally, a hit detector of the one or more second cache entry event detector(s) 208B can decrement a hit counter of the one or more second counters 210B in response to a detected replacement of a cache entry in the second set of cache entries 204B.

As illustrated in FIG. 2, example system 200 can also include replacement policy selection circuitry 212. Replacement policy selection circuitry 212 can include a first selector 214A, a second selector 214B, and one or more threshold conditions 216 (e.g., a threshold number of hits on a given set of cache entries, a threshold number of accesses of the given set of cache entries, a threshold criticality of accesses of the given set of cache entries, etc.). First selector 214A can be configured to observe the one or more first counters 210A and compare the one or more first counters 210A to respective one or more threshold conditions 216. Similarly, second selector 214B can be configured to observe the one or more second counters 210B and compare the one or more second counters 210B to respective one or more threshold conditions 216.

In response to detecting that a counter of the one or more first counters 210A has fallen below a corresponding threshold condition of the one or more threshold conditions 216, first selector 214A can take one or more actions. For example, first selector 214A can generate a signal (e.g., event) configured to trigger application of a different replacement policy (e.g., different than a current replacement policy recently applied to the first set of cache entries 204A) to the first set of cache entries 204A. Alternatively or additionally, first selector 214A can reset the one or more first counters 210A to one or more initial values.

Similarly, in response to detecting that a counter of the one or more second counters 210B has fallen below a corresponding threshold condition of the one or more threshold conditions 216, second selector 214B can take one or more actions. For example, first selector 214B can generate a signal (e.g., event) configured to trigger application of a different replacement policy (e.g., different than a current replacement policy recently applied to the second set of cache entries 204B) to the second set of cache entries 204B. Alternatively or additionally, first selector 214A can reset the one or more first counters 210A to one or more initial values.

As illustrated in FIG. 2, example system 200 can also include cache entry replacement circuitry 218. Cache entry replacement circuitry 218 can include first cache entry manager 220A, second cache entry manager 220B, first cache entry replacement policy 222A, and second cache entry replacement policy 222B. First cache entry replacement policy 222A, and second cache entry replacement policy 222B can be different cache entry replacement policies. In some implementations, first cache entry replacement policy 222A can correspond to a static re-reference interval prediction replacement policy and second cache entry replacement policy 222B can correspond to a least recently used replacement policy. First cache entry manager 220A can be configured to apply a current replacement policy when performing cache entry replacement in the first set of cache entries and second cache entry replacement manager can be configured to apply a current replacement policy when performing cache entry replacement in the first set of cache entries. In some implementations, both the first cache entry manager 220A and the second cache entry manager 220B can be configured to initially utilize the first cache entry replacement policy 222A at startup of the system 200. Thus, both the first cache entry manager 220A and the second cache entry manager 220B can initially apply the first replacement policy (e.g., the static re-reference interval prediction replacement policy) to their respective sets of cache entries. Additionally or alternatively, the first cache entry manager 220A and the second cache entry manager 220B can be configured to respond to the replacement policy selection circuitry 212 by simultaneously applying a first one of the different replacement policies when performing cache entry replacement in the first set of cache entries 204A and a second one of the different replacement policies when performing cache entry replacement in the second set of cache entries 204B.

First cache entry replacement circuitry 218 can be configured to dynamically switch, for an individual set of cache entries, from a first replacement policy to a second replacement policy in response to one or more signals received from replacement policy selection circuitry 212 (e.g., when a hit rate and/or a replacement rate tracked for the individual set of cache entries meets a threshold condition). For example, first cache entry manager 220A can be responsive to the signal (e.g., event) from first selector 214A. In this example, receipt of the signal from first selector 214A can trigger first cache entry manager 220A to switch from a first cache entry replacement policy 222A to a second cache entry replacement policy 222B and/or from a second cache entry replacement policy 222B to the first cache entry replacement policy 222A. Similarly, second cache entry manager 220B can be responsive to the signal (e.g., event) from second selector 214B. In this example, receipt of the signal from second selector 214B can trigger second cache entry manager 220B to switch from a first cache entry replacement policy 222A to a second cache entry replacement policy 222B and/or from a second cache entry replacement policy 222B to the first cache entry replacement policy 222A. Thus, cache entry replacement circuitry 218 can implement independent, simultaneous application of same and/or different replacement policies when replacing cache entries in the first set of cache entries 204A and the second set of cache entries 204B.

Further implementations of system 200 can include more than two sets of cache entries in cache 202 and/or more than two different cache entry replacement policies in cache entry replacement circuitry 218. In implementations having more than two sets of cache entries in cache 202, cache monitoring circuitry can have additional cache entry event detectors and additional counters, replacement policy selection circuitry 212 can have additional selectors, and cache entry replacement circuitry can have additional cache entry managers.

In implementations involving more than two different cache entry replacement policies in cache entry replacement circuitry 218, the cache entry managers (e.g., first cache entry manager 220A and/or second cache entry manager 220B) can cycle through the more than two different cache entry replacement policies by switching from a current cache entry replacement policy to a next cache entry replacement policy in an ordered list of the more than two replacement policies. Alternatively or additionally, the cache entry managers (e.g., first cache entry manager 220A and/or second cache entry manager 220B) can track performance of individual replacement policies applied to their respective sets of cache entries and preferentially select a next replacement policy that did not recently perform poorly or that recently exhibited superior performance. Examples of tracked performance can include tracked amounts of time individual replacement policies were applied and/or counter value histories (e.g., average and/or highest counter value achieved) by recent applications of individual replacement policies. Examples of poor performance can include application of a replacement policy for a relatively brief amount of time compared to other replacement policies and/or achievement of a relatively low counter value history compared to other replacement policies during recent application of the replacement policy. Examples of superior performance can include application of a replacement policy for a relatively lengthy amount of time compared to other replacement policies and/or achievement of a relatively high counter value history compared to other replacement policies during recent application of the replacement policy.

The term “computer-readable medium,” as used herein, can generally refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 3 illustrates an example computer-implemented method 300 for cache entry replacement. The steps shown in FIG. 3 can be performed by any suitable computer-executable code and/or computing system, including system 100 in FIG. 1, system 200 in FIG. 2, and/or variations or combinations of one or more of the same. In one example, each of the steps shown in FIG. 3 can represent an algorithm whose structure includes and/or is represented by multiple sub-steps, examples of which will be provided in greater detail below.

As illustrated in FIG. 3, at step 302 one or more of the systems described herein can monitor utilizations of sets of cache entries. For example, cache monitoring module 104 and/or cache monitoring circuitry 206, as part of system 100 in FIG. 1 and/or system 200 in FIG. 2, can monitor a first utilization of a first set of cache entries of a cache and a second utilization of a second set of cache entries of the cache.

The term “cache,” as used herein, can generally refer to a hardware or software component that stores data so that future requests for that data can be served faster. For example, and without limitation, a cache can correspond to an instruction cache, a level one data cache, a level two data cache, a level three data cache, an optimizer plus cache, a branch target buffer, etc.

The term “cache entries,” as used herein, can generally refer to a chunk of memory in a cache that stores data as a result of a store operation. For example, and without limitation, a cache entry can correspond to a cache line, a cache block, a row of cache, etc. In this context, size of a cache entry can be configurable, and a cache entry can store several bytes or words of data in some configurations. Additionally, cache entries can be grouped into sets comprising multiple cache entries, such as four lines, blocks, or rows of cache. The number of lines, blocks, or rows per set can be determined by a layout of the cache (e.g., direct mapped, set-associative, fully associative, etc.)

The term “utilization,” as used herein, can generally refer to the action of making practical and effective use of something. For example, and without limitation, utilization, in the context of cache entries, can generally refer to hits on cache entries, accesses of cache entries, criticality of accesses of cache entries, etc. For example, cache hits can be served by reading data from the cache, and a cache hit can occur when the requested data can be found in a cache, while a cache miss can occur when it cannot. In this context, a cache access can include both hits and misses. Cache access criticality can correspond to an assigned or determined criticality classification of a cache load resulting an access, and this criticality can be assigned to individual cache entries and/or sets of cache entries. In this context, criticality of a cache load can be determined based on various criteria, such as an amount of latency observed in retrieving data from a lower level of cache in the event of a miss.

The term “monitor,” as used herein, can generally refer to watching, keeping track of, and/or checking (e.g., for a particular purpose). For example, and without limitation, monitoring, in the context of cache utilization, can include managing (e.g., incrementing and/or decrementing) one or more performance counters that track cache utilization, such as hits on cache entries, accesses of cache entries, criticality of accesses of cache entries, etc.

The systems described herein can perform step 302 in a variety of ways. In one example, cache monitoring module 104 and/or cache monitoring circuitry 206, as part of system 100 in FIG. 1 and/or system 200 in FIG. 2, can maintain a first counter to track the first utilization and maintain a second counter to track the second utilization. In some implementations, the cache can correspond to an instruction cache, a level one data cache, a level two data cache, a level three data cache, an optimizer plus cache, or a branch target buffer.

The term “branch target buffer,” as used herein, can generally refer to a type of cache that can store branch instructions executed by a processor. For example, and without limitation, a branch target buffer can correspond to a data structure (e.g., table) that can maintain a number (e.g., several hundred or thousand) that can record a destination of a branch and a history regarding whether the branch was taken.

At step 304 one or more of the systems described herein can select replacement policies. For example, replacement policy selection module 106 and/or replacement policy selection circuitry 212, as part of system 100 in FIG. 1 and/or system 200 in FIG. 2, can select, in response to the monitoring, a first replacement policy for the first set of cache entries and a second replacement policy for the second set of cache entries.

The term “replacement policy,” as used herein, can generally refer to optimizing instructions or algorithms which a computer program or hardware-maintained structure can utilize to manage a cache of information. For example, and without limitation, cache entry replacement policy can refer to a re-reference interval prediction (RRIP) based policy (e.g., static re-reference interval prediction replacement policy (SRRIP)) and/or a recency-based policy (e.g., least recently used (LRU) replacement policy. Other example cache entry replacement policies can include Belady's algorithm, random replacement (RR), queue based policies (e.g., first in first out (FIFO), last in first out (LIFO), and/or first in last out (LIFO)), other recency-based policies (e.g., time-aware LRU, most recently used (MRU), segmented LRU, LRU approximation (e.g., pseudo LRU (pLRU), clock pro, etc.), frequency-based policies (e.g., least frequently used (LFU), least frequent recently used (LFRU), LFU with dynamic aging (LFUDA), other RRIP-based policies (e.g., bimodal RRIP (BRRIP), dynamic RRIP (DRRIP), policies approximating Belady's algorithm (e.g., hawkeye, mockingjay), machine learning policies, and other policies (e.g., low inter-reference recency set (LIRS), adaptive replacement cache, clock with adaptive replacement, multi-queue, pannier, etc.).

The term “static re-reference interval prediction replacement policy,” as used herein, can generally refer to a cache replacement policy that can insert lines with a re-reference prediction value (RRPV) of maximum re-reference interval prediction (maxRRIP). For example, and without limitation, a line which has just been inserted by SRRIP can be the most likely to be evicted on a cache miss.

The term “least recently used replacement policy,” as used herein, can generally refer to a recency-based replacement policy that discards least-recently used items first. For example, and without limitation, LRU can replace a line in a cache that has stayed in the cache longest without any reference to it by, for example, keeping track of what was used and when. Example LRU replacement policies can employ age bits for cache lines and track the least-recently-used cache line based on these bits. When a cache line is used, the ages of the other cache lines can change.

The systems described herein can perform step 304 in a variety of ways. In one example, replacement policy selection module 106 and/or replacement policy selection circuitry 212, as part of system 100 in FIG. 1 and/or system 200 in FIG. 2, can select the first replacement policy and the second replacement policy at least in part by selecting, in response to the first counter failing to meet a threshold condition, to continue to apply the first replacement policy to the first set of cache entries, and select, in response to the second counter meeting the threshold condition, the second replacement policy for application to the second set of cache entries. Additionally or alternatively, replacement policy selection module 106 and/or replacement policy selection circuitry 212, as part of system 100 in FIG. 1 and/or system 200 in

FIG. 2, can select the first replacement policy and the second replacement policy at least in part by dynamically switching, for an individual set of cache entries, from the first replacement policy to the second replacement policy in response to a hit rate and/or a replacement rate tracked for the individual set of cache entries meeting a threshold condition. In some implementations, the threshold condition can correspond to a threshold number of hits on a given set of cache entries, a threshold number of accesses of the given set of cache entries and/or a threshold criticality of accesses of the given set of cache entries.

At step 306 one or more of the systems described herein can simultaneously apply the replacement policies. For example, cache entry replacement module 108 and/or cache entry replacement circuitry 218, as part of system 100 in FIG. 1 and/or system 200 in FIG. 2, can simultaneously apply, in response to the selecting, the first replacement policy when performing cache entry replacement in the first set of cache entries and the second replacement policy when performing cache entry replacement in the second set of cache entries.

The systems described herein can perform step 306 in a variety of ways. In one example, the second replacement policy can be different form the first replacement policy. For example, the first replacement policy and the second replacement policy can include a static re-reference interval prediction replacement policy and a least recently used replacement policy. Additionally or alternatively, cache entry replacement module 108 and/or cache entry replacement circuitry 218, as part of system 100 in FIG. 1 and/or system 200 in FIG. 2, can apply different replacement policies to more than two sets of cache entries. Additionally or alternatively, cache entry replacement module 108 and/or cache entry replacement circuitry 218, as part of system 100 in FIG. 1 and/or system 200 in FIG. 2, can apply different replacement policies selected from more than two different cache entry replacement policies.

In implementations involving more than two different cache entry replacement policies, cache entry replacement module 108 and/or cache entry replacement circuitry 218, as part of system 100 in FIG. 1 and/or system 200 in FIG. 2, can cycle through the more than two different cache entry replacement policies by switching from a current cache entry replacement policy to a next cache entry replacement policy in an ordered list of the more than two replacement policies. Alternatively or additionally, cache entry replacement module 108 and/or cache entry replacement circuitry 218, as part of system 100 in FIG. 1 and/or system 200 in FIG. 2, can track performance of individual replacement policies applied to their respective sets of cache entries and preferentially select a next replacement policy that did not recently perform poorly or that recently exhibited superior performance. Examples of tracked performance can include tracked amounts of time individual replacement policies were applied and/or counter value histories (e.g., average and/or highest counter value achieved) by recent applications of individual replacement policies. Examples of poor performance can include application of a replacement policy for a relatively brief amount of time compared to other replacement policies and/or achievement of a relatively low counter value history compared to other replacement policies during recent application of the replacement policy. Examples of superior performance can include application of a replacement policy for a relatively lengthy amount of time compared to other replacement policies and/or achievement of a relatively high counter value history compared to other replacement policies during recent application of the replacement policy.

FIG. 4 illustrates example cache entry replacement techniques 400, 402, and 404. In these example techniques, the branch target buffer (BTB) is employed as an example cache structure and LRU and SRRIP are employed as example replacement techniques. However, the disclosed systems and methods can be implemented with any type of cache structure and any types of replacement policies.

Cache entry replacement technique 400 can correspond to utilization of a least recently used (LRU) replacement policy. LRU is a popular BTB replacement technique that expects the recently allocated entries to continue to occur again in the immediate future and inserts them in a state in which they will be replaced last. The entry replaced is the one that was accessed the furthest in the past. LRU can perform poorly for applications that have a high reuse distance or those with frequent bursts of streaming accesses.

Cache entry replacement technique 402 can correspond to utilization of a static re-reference interval prediction replacement policy (SRRIP). SRRIP was proposed to address the shortcomings of LRU as it is more resistant to streaming accesses. SRRIP is resistant to streaming accesses because it separates new allocations from hits to previously allocated entries. New allocations are inserted in a state close to a LRU state and can potentially be replaced sooner. This insertion can aid in handling streaming traffic and limit impact on other recurring entries in the same set. Once a prior existing entry sees a hit, that entry is only then moved to a most recently used (MRU) state and is the last to be considered for replacement. While this technique makes SRRIP resistant to streaming traffic, it can suffer from thrashing when the reuse distance is uniformly high for all accesses in the set. It can also perform worse than LRU in these cases as new allocations always occur over recent allocations and can lead to more thrashing.

Cache entry replacement technique 404 can correspond to an implementation of the disclosed systems and methods referred to herein as dynamic SRRIP (DynSSRIP). DynSSRIP can implement counters per set (e.g., hit counter 406) and can track the hit rate and replacement rate seen per set simultaneously to guide how the LRU and SSRIP policies are tuned per set. This tuning can provide much more flexibility and performance optimization over other implementations, such as set dueling, that involve sampling of a few sets and that apply a same replacement policy across all sets of cache entries of a cache under the assumption that the same behavior occurs across all sets.

A primary difference between LRU and SRRIP is the insertion state of a newly allocated entry. For example, LRU always inserts an entry at the MRU state and, therefore, the entry is the last to be considered for replacement. In contrast, SRRIP allocates a new entry close to the LRU state so that it will soon be replaced unless it encounters a hit in the immediate future. By deciding what this insertion state for a new entry should be, DynSRRIP dynamically switches between these two schemes. This dynamic switching can be accomplished with very limited additional hardware, thus enabling seamless switching between two replacement techniques.

FIG. 4 provides a brief overview of DynSSRIP. To learn the runtime characteristics of each set, DynSSRIP can associate a “N” bit hit counter 406 with each set. The size of the counter can be determined based on the performance opportunity that the applications of interest exhibit. Initially, all sets can start with a SRRIP based insertion policy. The hit counter 406 can be incremented when an entry in the particular set sees a hit and decremented when there is a replacement. Once the hit counter goes below a threshold value, the insertion scheme can flip between SRRIP and LRU to allow more opportunity for the newly allocated entry to see a hit and limit the thrashing. Later, if the hit counter 406 goes below the threshold value again, the insertion scheme can switch from LRU to SRRIP. For software with a large cache footprint, DynSRRIP provides additional instructions per clock (IPC) gains over LRU by reducing cache misses.

FIG. 5 illustrates example applications of cache entry replacement techniques 500 and 550. For example, cache entry replacement techniques 500 can correspond to set dueling, whereas cache entry replacement technique 550 can correspond to one or more implementations of the disclosed systems and methods, such as DynSRRIP.

Level 2 (L2) caches can adopt cache entry replacement techniques 500 (e.g., set dueling) to choose between pLRU and RRIP. Set dueling, however, adopts a single policy across all sets. In contrast, depending on values of set-specific counters 552A, 552B, and 552C, cache entry replacement technique 550 (e.g., DynSRRIP) can tune the policies according to the sets that map to the counters 552A, 552B, and 552C. As a result, one or more sets of a cache 554 can use pLRU while one or more other sets of the same cache 554 can use RRIP simultaneously, resulting in optimal use of the entries that map to the individual sets.

As set forth above, systems and methods for cache entry replacement are disclosed. For example, by monitoring utilizations of sets of cache entries, selecting a first replacement policy for a first set of cache entries and a second replacement policy for a second set of cache entries, and simultaneously applying the replacement policies when performing cache entry replacement in the sets of cache entries, the disclosed systems and methods can achieve improved performance of computer processors. This improved performance arises when different sets in the cache entries are of different nature, resulting in the behavior observed in them differing. Consequently using the same replacement technique (e.g., based on the same criteria) across all sets can be sub-optimal. Instead of applying the same replacement technique across all sets of cache entries of a cache, the disclosed systems and methods can dynamically switch between multiple replacement techniques at runtime based on observed behaviors and tune the behaviors of the sets to retain the most useful entries.

Particular implementations of the disclosed systems and methods can achieve numerous additional benefits. For example, some implementations can achieve seamless transition between different insertion states that two or more different replacement schemes (e.g., least recently used (LRU) and static re-reference interval prediction (SRRIP)) provide. Some of these implementations can also enable the seamless switching with negligible hardware. Further, some implementations can allow the different sets to utilize the replacement policy that performs best for them based on the performance counters (PCs) they observe.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 and/or example system 200 in FIG. 2 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 and/or example system 200 in FIG. 2 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 and/or example system 200 in FIG. 2 can be implemented within a virtual environment. For example, the modules and/or data described herein can reside and/or execute within a virtual machine. As used herein, the term “virtual machine” can generally refer to any operating system environment that is abstracted from computing hardware by a virtual machine manager (e.g., a hypervisor).

In some examples, all or a portion of example system 100 in FIG. 1 and/or example system 200 in FIG. 2 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
cache monitoring circuitry configured to track a first utilization of a first set of cache entries of a cache and a second utilization of a second set of cache entries of the cache;
replacement policy selection circuitry configured to respond to the cache monitoring circuitry by selecting a first replacement policy for the first set of cache entries and a second replacement policy for the second set of cache entries; and
cache entry replacement circuitry configured to respond to the replacement policy selection circuitry by simultaneously applying the first replacement policy when performing cache entry replacement in the first set of cache entries and the second replacement policy when performing cache entry replacement in the second set of cache entries.

2. The device of claim 1, wherein the cache monitoring circuitry is configured to track the first utilization and the second utilization at least in part by:
maintaining a first counter to track the first utilization; and
maintaining a second counter to track the second utilization.

3. The device of claim 2, wherein the replacement policy selection circuitry is configured to select the first replacement policy and the second replacement policy at least in part by:
selecting, in response to the first counter failing to meet a threshold condition, to continue to apply the first replacement policy to the first set of cache entries; and
selecting, in response to the second counter meeting the threshold condition, the second replacement policy for application to the second set of cache entries.

4. The device of claim 3, wherein the threshold condition corresponds to at least one of:
a threshold number of hits on a given set of cache entries;
a threshold number of accesses of the given set of cache entries; or
a threshold criticality of accesses of the given set of cache entries.

5. The device of claim 1, wherein the replacement policy selection circuitry is configured to select the first replacement policy and the second replacement policy at least in part by:
dynamically switching, for an individual set of cache entries, from the first replacement policy to the second replacement policy in response to at least one of a hit rate or a replacement rate tracked for the individual set of cache entries meeting a threshold condition.

6. The device of claim 1, wherein the first replacement policy and the second replacement policy include:
a static re-reference interval prediction replacement policy; and
a least recently used replacement policy.

7. The device of claim 1, wherein the cache corresponds to one of:
an instruction cache;
a level one data cache;
a level two data cache;
a level three data cache;
an optimizer plus cache; or
a branch target buffer.

8. The device of claim 1, wherein the second replacement policy is different from the first replacement policy.

9. A system comprising:
a memory storing a cache that includes a first set of cache entries and a second set of cache entries; and
one or more physical processors configured to:
monitor a first utilization of the first set of cache entries of the cache and a second utilization of the second set of cache entries of the cache;
select, in response to the monitored first utilization and the monitored second utilization, a first replacement policy for the first set of cache entries and a second replacement policy for the second set of cache entries; and
simultaneously apply, in response to the selection of the first replacement policy and the second replacement policy, the first replacement policy when performing cache entry replacement in the first set of cache entries and the second replacement policy when performing cache entry replacement in the second set of cache entries.

10. The system of claim 9, wherein the one or more physical processors is configured to monitor the first utilization and the second utilization at least in part by:
maintaining a first counter to track the first utilization; and
maintaining a second counter to track the second utilization.

11. The system of claim 10, wherein the one or more physical processors is configured to select the first replacement policy and the second replacement policy at least in part by:
selecting, in response to the first counter failing to meet a threshold condition, to continue to apply the first replacement policy to the first set of cache entries; and
selecting, in response to the second counter meeting the threshold condition, the second replacement policy for application to the second set of cache entries.

12. The system of claim 11, wherein the threshold condition corresponds to at least one of:
a threshold number of hits on a given set of cache entries;
a threshold number of accesses of the given set of cache entries; or
a threshold criticality of accesses of the given set of cache entries.

13. The system of claim 9, wherein the one or more physical processors is configured to select the first replacement policy and the second replacement policy at least in part by:
dynamically switching, for an individual set of cache entries, from the first replacement policy to the second replacement policy in response to at least one of a hit rate or a replacement rate tracked for the individual set of cache entries meeting a threshold condition.

14. The system of claim 9, wherein the first replacement policy and the second replacement policy include:
a static re-reference interval prediction replacement policy; and
a least recently used replacement policy.

15. The system of claim 9, wherein the cache corresponds to one of:
an instruction cache;
a level one data cache;
a level two data cache;
a level three data cache;
an optimizer plus cache; or
a branch target buffer.

16. The system of claim 9, wherein the second replacement policy is different from the first replacement policy.

17. A method comprising:
monitoring, by at least one physical processor, a first utilization of a first set of cache entries of a cache and a second utilization of a second set of cache entries of the cache;
selecting, by the at least one physical processor and in response to the monitoring, a first replacement policy for the first set of cache entries and a second replacement policy for the second set of cache entries; and
simultaneously applying, by the at least one physical processor and in response to the selecting, the first replacement policy when performing cache entry replacement in the first set of cache entries and the second replacement policy when performing cache entry replacement in the second set of cache entries.

18. The method of claim 17, wherein the monitoring the first utilization and the second utilization includes:
maintaining a first counter to track the first utilization; and
maintaining a second counter to track the second utilization.

19. The method of claim 17, wherein the selecting the first replacement policy and the second replacement policy includes:
dynamically switching, for an individual set of cache entries, from the first replacement policy to the second replacement policy in response to at least one of a hit rate or a replacement rate tracked for the individual set of cache entries meeting a threshold condition.

20. The method of claim 17, wherein the first replacement policy and the second replacement policy include:
a static re-reference interval prediction replacement policy; and
a least recently used replacement policy.
